(19) United States
(12) Patent Application Publication
(10) Pub. No.: US 2007/0244921 A1
(43) Pub. Date: Oct. 18, 2007

(54) Method, apparatus and computer-readable medium to provide customized classification of documents in a file management system

(76) Inventor: Roger Blair, Atlanta, GA (US)

Correspondence Address: McIntyre Harbin & King, 500 Ninth Street SE, Washington, DC, 20003, US

(21) Appl. No.: 11/783,909

(22) Filed: Apr. 13, 2007

Related U.S. Application Data
(60) Provisional application No. 60/792,315, filed on Apr. 14, 2006.

(51) Int. Cl. G06F 7/00

(52) U.S. Cl. 707/102

(57) ABSTRACT

A customizable file template for use in a document or file management system to control how document files are classified, imported, and/or retrieved from the system. The method, as well as a corresponding apparatus and computer-readable medium, enables an administrator to generate a custom classification tree unique to his or her business enterprise by providing a user interface from which to select folder types and subclassifying document types for selected folder types. Editable folder types and document types are provided in respective regions of a graphical user interface. Selected folder and document types are placed into a scratchpad area of the graphical user interface to build the customized file tree. The customized classification tree is stored for subsequent use by a classifier to classify and import files into the document management system, and/or by an end user to access and view stored files arranged according to the customized file tree.

### CROSS-REFERENCE TO RELATED PATENTS AND PATENT APPLICATIONS

This invention claims the benefit of Provisional Application Ser. No. 60/792,315 entitled “Document Management System, Method, and Computer-Readable Medium of Effect Implementation Thereof,” filed Apr. 14, 2006.

### BACKGROUND

This invention relates to computerized document or file management, but more specifically, to a system, method, and computer-readable medium to construct and/or utilize a customized file template to classify or access files according to a desired order, grouping, or classification.

The task of classifying content, e.g., text, image, or multimedia files (hereafter “documents,” “files” or “document files”), of a document or file management system (hereafter “document management system” or “system”) is known as taxonomy. Taxonomy is generally defined as a technique for naming and organizing things into groups that share similar characteristics. In a business enterprise utilizing a large number of varied documents, it is sometime difficult to efficiently or conveniently access, analyze, process or archive document files. Ideally, in order to find a desired piece of information or to evaluate the content for certain information, it is desirable to store, retrieve, and/or display documents in an organized fashion. A classification structure aids in organizing document files. The classification process, however, requires a fair amount of human interaction and is susceptible to much human error. Incorrectly classified content may become lost or difficult to find. Thus, providing efficiency in the classification process and/or reducing the amount of human effort to classify or identify documents significantly reduces errors of the enterprise in managing its documents.

Current state of the art to classify content in a document management system includes the use of a drop-down menu or freeform text box where a user makes selections with an input device such as a keyboard and/or mouse, or enters text via a keyboard, and then imports the content according to the selections made. Such techniques frequently do not provide a clear picture of where or how new content will exist in a file structure after being imported into the system, and often results in confusion or incorrect classification of the newly imported content.

The present invention, on the other hand, overcomes prior limitations in the art by, among other things, providing greater flexibility in defining the file classification structure during the classification process, reducing the degree of human effort required to classify the content, providing greater visual perception of file structure (i.e., a “big picture” view of the classification structure) to assist an administrator in designing a customized file tree structure or a subsequent user in classifying/importing content according to the customized file tree structure defined by the administrator. The invention also helps a user to locate desired content in a document management system.

### SUMMARY OF THE INVENTION

According to a first aspect of the invention, there is provided a computer-implemented method to enable a user to build a customized file tree structure for use in a document management system wherein the method comprises providing a first region of a graphical user interface (scratchpad area) of a computer workstation within which to build (and/or visualize) the customized file tree structure, providing a list of available folder types in a second region of the graphical user interface from which to select a folder type, providing a list of document types in a third region of the graphical user interface from which to select a subclassification of a folder type, and building the customized file tree structure in said first region by transferring desired folder types from the second region to the first region and further subclassifying transferred folder types by transferring at least one document type from the third region to the first region for desired ones of the folder types whereby to build the customized file tree structure. The method may further include storing the customized file tree structure in a document management system for subsequent access and use in importing document files into the system. Another aspect of the method includes, in the transferring steps, dragging and dropping selected folder types and selected document types respectively from the second and third regions to the first region of the graphical user interface. A further aspect of the method includes providing an editing tool to enable a user (classification designer) to create additional folder types or document types in the first, second, or third regions of the graphical user interface. The folder types and document types for the method or system may be uniquely suited to characterize insurance underwriting files or other industry specific files.

Another embodiment of the invention comprises a computer-implemented method of enabling a user to construct a customized file tree comprising providing the user with an available group of file types, optionally providing the user with an available group of document types for the file types, and enabling the user to construct an ordered, customized file tree by (i) selecting a file type from the available group of file types and placing the selected file types at a desired position in the file tree and (ii) for a file type placed into the file tree, selecting at least one document type from the available group of document types and placing the at least one document type at a position in the file tree structure associated with the selected file type. This embodiment may further include providing an editing tool to enable the user to define by textually entering into the file tree structure a new folder type and/or an associated new document type.

A further embodiment of the invention comprises a computer-implemented method of classifying and importing document files into a document management system comprising providing a graphical user interface to display a predefined file tree structure in a window thereof, identifying a first document file to be classified and imported into the document management system, selecting a location within the predefined file tree structure within which to classify the document file, importing the first document file into the document management system according to the location identified in the identifying step, and iteratively repeating said identifying, selecting, and importing steps to classify and import further document files. This embodiment may additionally include storing imported document files in a central file storage system of the document management system. A further embodiment may additionally include the steps of generating a classification identifier tag according to the location identified in the selecting step, and storing the classification identifier tag along with each document file when imported into the document management system whereby to enable listing and retrieving the file according to the predefined file tree structure.

A further embodiment of the invention includes a computer-implemented method of classifying and importing document files into a document management system comprising displaying a predefined file tree structure in a first region of a graphical user interface, enabling a user (classifier) to identify a document file to be classified according to the predefined file tree structure, selecting a location within the predefined file tree structure displayed in the first region of the graphical user interface, and importing the document file into the document management system according to the selected location of the customized file tree structure. The importing step of this embodiment may also include automatically producing a classification tag indicative of a classification assigned to the document file and storing the classification tag along with the document file (or in a separate cross-referenced, linked database records associated with the document file) to enable the document management system to track, maintain, or subsequently retrieve the document file according to the customized file tree structure. The classification tag may also be stored in a linked database associated with the document file.

A further embodiment of the invention includes a computer-implemented method of retrieving document files stored in a document management system and classified according to a predefined file tree structure comprising obtaining a predefined classification tree structure represented by a group of file identifiers indicative of folder types and document types of the predefined classification tree structure, accessing document files in a database according to the file identifiers, and displaying a list of document files according to the classification tree structure whereby to enable a user to access a desired document file. The displaying step may further include displaying the document files in a same ordered arrangement provided by the predefined file tree structure.

In accordance with another embodiment of the invention, there is provided a method of accessing and retrieving a document file stored in a database of a file management system according to a predefined classification tree structure comprising generating a group of classification identifiers to provide a user with a listing of document files arranged according to a predefined classification tree structure, choosing a document file from the file listing, retrieving the chosen file from the database, and rendering the chosen document file on an output device. The generating step may include searching the database for file identifiers defining the classification of document files according to the predefined classification tree structure, and displaying retrieved files in an ordered arrangement according to the predefined classification tree structure.

In accordance with another aspect of the invention, there is provided a document management system to enable a user (classification designer) to build a customized file tree structure comprising a computer workstation including a local processor and display terminal to provide the user with an interactive graphical user interface and a processor to provide a scratchpad area within which to build the customized file tree structure where the workstation further includes a first program module to provide a list of available folder types from which to choose and create the customized file tree structure, a second program module to provide a list of available document types from which to further choose and associate with a selected file folder, and a third program module to detect user activity in choosing and building folder types and document types, and a fourth program module to store the customized classification tree structure for subsequent use during file classification or retrieval. The system may also include a memory storage device within which to store said customize file tree structure on a central storage device.

In accordance with another aspect of the invention, there is provided a document management apparatus to classify document files of a document management system comprising a workstation that includes a data processing device and a display terminal where the processing device includes a first program module to provide a classifier with an interactive graphical user interface that displays a predefined classification tree, a second program module to register an identification of a document file made by the classifier, a third program module to register a selection in the predefined classification tree made by the classifier within which to classify the document file, and a fourth program module to effect importation of the document file into a storage of the document management system according to the registered selection within the predefined classification tree. The system may further include a fifth program module that generates file identifiers indicative of the predefined classification tree and that stores the file identifiers along with each document file imported into the document management system.

In accordance with another aspect of the invention, there is provided a computer-readable medium that stores program instructions for execution by a digital data processor of a document management system to enable a user to build a customized file tree structure, to effect importation of a file into the document management system by enabling selection of a file and effecting assignment of a position within said customized file tree structure, to effect storage of document files in a database according to the customized file structure tree, and to effect uniform display of document files according to the customized file tree structure.

In yet a further aspect of the invention, there is provided a computer-readable medium that stores program instructions for execution by a digital data processor of a document management system to enable a user to build a customized file tree wherein the program instructions are effective to provide a first region of a graphical user interface within which to build the customized file tree, to provide a second region of the graphical user interface that provides a list of available file folders within which to classify document files, to provide a third region of the graphical user interface that provides a list of available document types to subclassify selected file folders, and to register actions by the user in building the customized file tree by selecting folder types and document types. The program instructions may further enable a user to classify and import document files into the document management system by providing a display of the customized file tree and enabling a user to identify a file and a location within the customized file tree to classify and store the document files.

Other aspects and features of the invention will become apparent upon review of the following illustrative embodiments taken in connection with the accompanying drawings. The invention, though, is pointed out with particularity by the appended claims.

### BRIEF DESCRIPTION OF THE DRAWINGS

FIG. 1 is a graphical user interface (GUI) depicting display of a customizable file tree structure useful according to an aspect of the present invention for enabling a user or administrator to define a classification structure for use in subsequently entering in or retrieving content from a document management system.

FIG. 2 shows an import mode of a GUI to enable a user to classify and/or import documents into a document management system according to a predefined classification or tree structure.

FIG. 3 shows an exemplary framework for accessing and/or retrieving stored documents from a document management system.

FIG. 4 depicts an exemplary method of generating a classification tree structure, optionally classifying/importing documents, and uniformly displaying a list of classified document files.

FIG. 5 shows a system useful for building a classification tree, classifying/importing document, or uniformly displaying documents of a file management system.

### DESCRIPTION OF ILLUSTRATIVE EMBODIMENTS

The present invention, which is commercially known as an ImageRight® File Template of a document management system developed by Advanced Solutions, Inc., provides a user with a clear visual indication of a predefined file structure or framework within which to classify documents or into which content may be entered, stored, or accessed. As a preliminary step, the invention enables an administrator (i.e., a classification designer) of a document management system to generate and/or modify the structure of a file template in a customized fashion so that documents may subsequently be imported and/or retrieved in a predefine way. When developing the classification structure, the invention assists the classification designer (or other user) to define a file tree structure in a customized way that is uniquely suited to the present business enterprise. Once defined, the file template embodying the customized tree enables importation of files into the document management system with minimal risk of errors. In other words, the file template also controls how files are classified, arranged, and imported in a document management system, as well as how these files are listed for retrieval from the system.

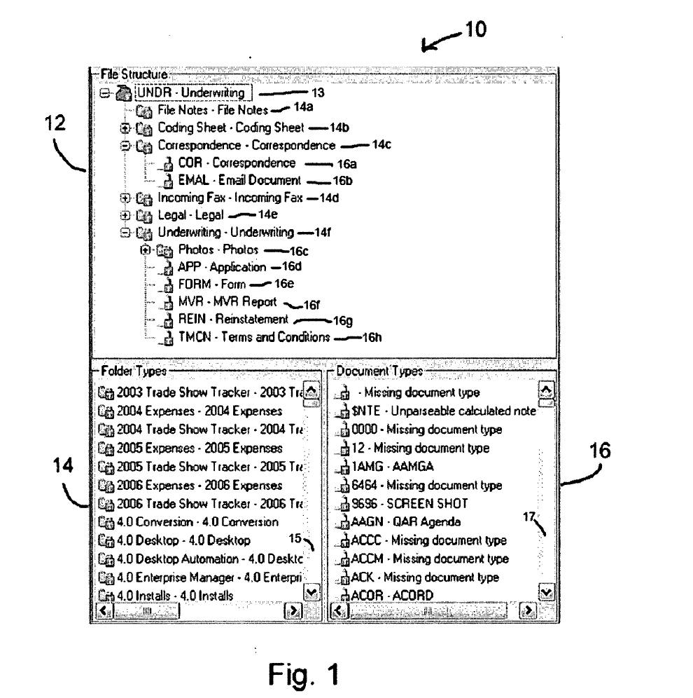

FIG. 1 illustrates a graphical user interface useful for developing or building a customized classification tree using a file template definition scheme comprising, for example, a folder type and a document type to be applied to selected folder types. Using conventional editing tools (e.g., drag-and-drop, or text editing), the administrator builds or modifies the file template by predefining a folder type parameter for a selected classification group in a file tree structure. Pane 12 of FIG. 1, for example, illustrates a customized classification group for “Underwriting” documents that was constructed from folder type and document type selections of pane 14 and 16. In the illustrated insurance underwriting example, the predefined file structure comprises a number of folder types identified as file notes 14a, coding sheets 14b, correspondence 14c, incoming faxes 14d, legal documents 14e, and underwriting documents 14f. These folder types 14a through 14f were selected (e.g., dragged and dropped) from available folder type selections of pane 14. Pane 14 only shows a portion of available folder types but may conventionally be scrolled at scroll bar 15 to effect display of other folder type selections. Instead of dragging and dropping a predefined folder type selection from pane 14 to build the file structure of pane 12, a new folder type in pane 12 may be constructed by conventional editing tools applied to pane 12, e.g., by using a “new folder” application response to a right mouse click on the “Underwriting” group 13.

The classifier may also define document types within any of the selected folders 14a through 14f of the file structure shown in pane 12. In the illustrated example, documents to be placed in correspondence folder 14c were further sub-classed or subcategorized as “CDR Correspondence” 116a and “EMAL” documents 16b. Available documents types for sub-classifying the folder types may similarly be dragged-and-dropped from available selections shown in pane 16, which may be scrolled at scroll bar 17 to visually display and access other available selections. Similarly, documents types of “Underwriting” folder 14f were selected from available selections contained in pane 16. In the illustrated example, the administrator defined “Underwriting” folder 14f to be further broken down into photo documents 16c, application documents 16d, forms 16e, MVR reports 16f, reinstatements 16g, and terms and conditions 16h.

Once the file tree of pane 12 is completed, it becomes a customize file tree structure useful to subsequently import or recall documents in the document management system of the particular enterprise. The thus constructed file template also defines a shell structure to be used to enter and classify documents.

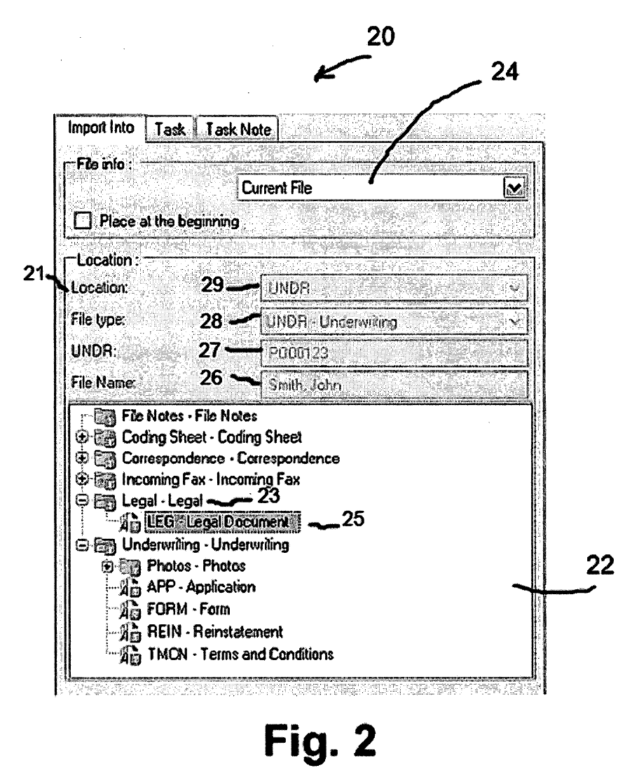

FIG. 2 illustrates how the customized file classification structure built according to the illustrated example of FIG. 1 may be used to import documents into a document management system. When a user (e.g., document classifier) wishes to add content, importation GUI 20 displays the previously developed file classification tree in pane 22 into which a file may be placed. The classification tree of pane 22 corresponds to the previously produced file classification of pane 12 of FIG. 1. Using a conventional menu drop-down box 24, the user locates and selects a “current file” from storage, e.g., from a storage location of a network or from a local storage device associated with the user's workstation. After identifying in box 24 the document file to be imported, the user selects an appropriate classification for that document file from a selection shown in pane 22. In the illustrated example, the user selected the “current file” of pane 24 to be classified as a “legal document” type 25 in the “Legal” file folder 23. Location box 21 identifies the file name “Smith, John” in box 26, an underwriting identifier “P000123” in box 27, a file type “underwriting” in box 28, and a location UNDR in box 29. Because pane 22 advantageously displays the entire tree, the user is better able to view the overall classification and assess the appropriate location for the imported document file.

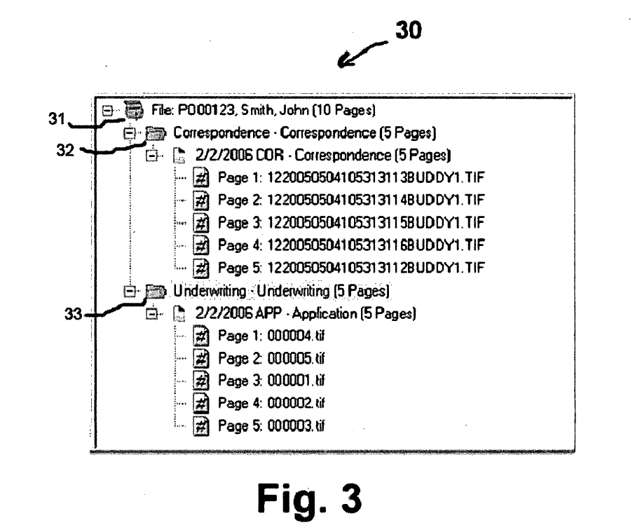

Once content has been appropriately classified and imported into the document management system, it may also be subsequently accessed, retrieved, displayed, or rendered in a uniform, consistent manner. FIG. 3 illustrates the order of contents of file folder 31 identified as “P000123” for John Smith. According to the predefined classification tree constructed by pane 12 of FIG. 1, the order of listed documents provides correspondence documents followed by underwriting documents. Predetermined folders which do not contain any documents can be omitted from the retrieval view. In the illustrated example, the “John Smith” file contains a five-page correspondence document 34 and a five-page underwriting document 35. If the “John Smith” file included “legal” documents, such documents would be listed between the correspondence and underwriting listings 32 and 33 according to the order specified by the file structure of pane 12 of FIG. 1. Similarly, if the “John Smith” file folder included a “coding sheet,” this would precede correspondence as specified by the order shown in pane 12 of FIG. 1. Thus, according to an important aspect of the invention, documents are also displayed or listed according to the customized order of folder types provided by the predefined classification tree.

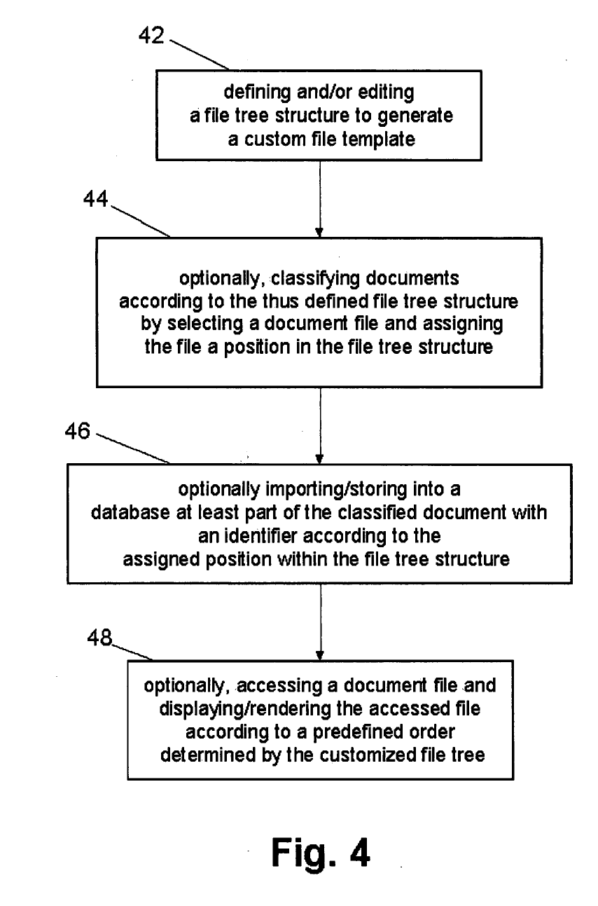

FIG. 4 depicts an illustrative method according to another aspect of the present invention, which comprises a step 42 of defining and/or modifying a file tree structure to generate a customized file template; an optional step 44 of classifying document files according to the thus defined file tree structure of step 42, which may include selecting a document file and assigning that file a position within the file tree structure defined in step 42; an optional step 46 of importing/storing at least part of the newly classified document files into a database of a document management system, which may include assigning a file identifier or tagging the imported file according to the assigned position within the file tree structure (in one embodiment, a file name, system assigned file name, and/or other file attributes may be stored on a text server along with the document file and any associated image of the document file may be stored on an image server so that they may both be retrieved together during subsequent display); and an optional step 48 of accessing document files of the file management systems and displaying such files according to a predefined order determined by the customized file tree structure defined in step 42.

The invention includes various embodiment of each step 42 through 48. The method of step 42 enables a classifier or system administrator to build a customized file tree structure. The invention is generally computer-implemented in that a graphical user interface and a database of stored files and document types are employed to assist the administrator in building the file template. An exemplary method of step 42, for example, may comprise providing the administrator (or other user) with an available group of file types, optionally providing the administrator with an available group of document types, and then enabling the administrator to construct an ordered, customized file tree structure by (i) selecting a file type from the available group of file types and placing the selected file type at a desired position in the file tree structure and (ii) for a file type placed into the file tree structure by the administrator, selecting a document type from the available group of document types and placing the selected document type at a position associated with the selected file type. Selecting and placing a file type and/or a document type may be conventionally accomplished by “dragging and dropping” a type designation from a provided list of available types set forth on a graphical user interface. Rather than selecting a file or document type from a stored cadre of available types provided to the classifier, the method may additionally include providing an editing tool to enable the classifier to define by textually entering into the file tree structure a “new folder” type and/or an associated “new document” type.

The method of steps 44 and 46 is typically performed, but not necessarily, independently or subsequently of the method of step 42. A user generally performs steps 44 and 46 at a workstation with the aid of a keyboard and “point-and-click” device after the administrator has built the customized file tree structure according to the method of step 42. Referring to FIG. 2, an exemplary method of classifying and/or importing document files comprises displaying the previously-defined customized file tree structure in a pane 22 of graphical user interface 20, enabling the classifier (or other user) to search and select a current document file 22 to be classified within the predefined customized file tree structure displayed in the graphical user interface, selecting a location within the customized file tree structure displayed on the graphical user interface, and entering/importing the current document file into the file management system according to the selected location of the customized file tree structure. Files to be classified and/or imported may be derived from any source of the classifier's choice, such as from locally stored or scanned document files or the classifier may search and obtain document files from other sources. The entering step may inherently and automatically produce system-generated tags or file identifiers (i.e., attributes) that are transparent to the user. These tags or file identifiers may be stored along with the document file (or in a separate cross-referenced, linked database records associated with the document file) to enable the document management system to track, maintain, or subsequently retrieve the document files according to the customized file tree structure. As tagging and file identifying techniques are known in the art and vary widely, the invention is not limited to any particular technique.

The method of step 48 of accessing or retrieving a document file within a document management system and displaying/rendering the file on a user workstation is generally performed independently and subsequently of the method of steps 42-46. Referring to FIG. 3, the accessing/displaying step comprises providing a user with an indication of a file listing arranged according to the customized file structure; choosing a document file in the file listing; retrieving the chosen file from a database of the document management system; and rendering the chosen document file on an output device, e.g., a printer or display monitor. Again, transparent to the user, the step of retrieving may include identifying tags or file identifiers according to the chosen file, using the identified tags/identifiers to search the database, and retrieving the file from the database. Advantageously, the files are displayed to or rendered for the user, as shown in FIG. 3, in the same uniform order provided by the customized file tree structure.

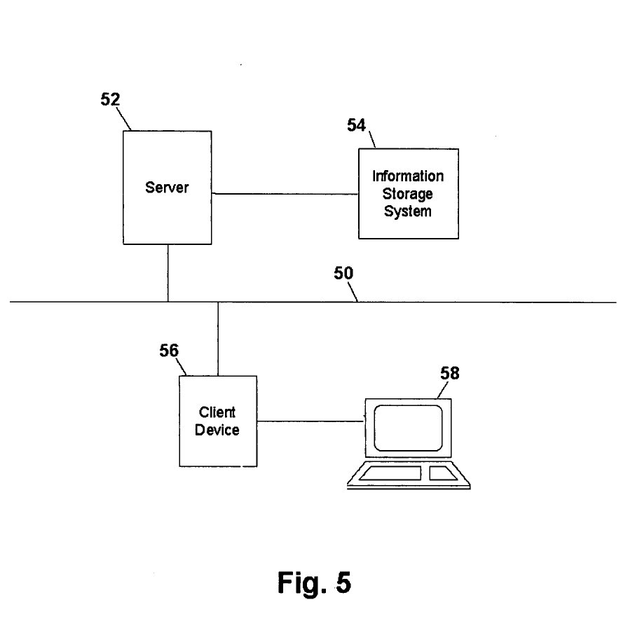

FIG. 5 shows an illustrative document management system typically configured on a local or wide area network 50 that may be used to build a customized file structure, to classify and import files into a document management system, or to display or render files of a structured file database on an I/O device.

When building a customized file tree structure, a workstation including a local processor 56 and display terminal 58 provides an administrator with the exemplary interactive graphical user interface of FIG. 1 and background processing action to effect display in pane 12 of a scratchpad area within which to build the customized file tree; to effect display in pane 14 of a list of available folder types from which to choose to create the customized file tree; to effect display in pane 16 of a list of available document types to further define documents that may be placed in the selected folder type categories; and to perform processing activity to detect classifier-actions in choosing and dragging/dropping folder types and document types from panes 12 and 16 into the scratchpad area 12. Available folder types and document types may be stored in memory storage of client device 56, or remotely available by accessing memory storage 54 of a local or remote server 52. Likewise, the completed customized file tree may, for subsequent access and use, be stored locally in a memory of device 56, or remotely in a memory 54 of server 52 for access or retrieval over network 50. Network 50 interconnects the server 52 with client device 56. Other servers, client devices and devices can also be interconnected via the network 50. Client device 56 may also provide editing tools to textually edit or build the customized file tree structure in pane 12, as previously explained. Generally, the workstation has the capability to implement each method described herein with respect to a system administrator, a classifier or subsequent user in order to classify, import, or render a document file.

The apparatus of FIG. 5 may also be used to classify or import document files into a document management system. In this case, the workstation comprising data processing device 56 and display terminal 58 provide a user with an interactive graphical user interface illustrated in FIG. 2. When provided with the graphical user interface, local client device 56 registers the user's identification of a current file in display bar 24 as well as the user's selection in pane 22 of a location within the displayed file tree to classify the current file. The illustration of FIG. 2 shows a user selection of “Legal Document” for the current file. Importation action may be effected by “entering” the document or by execution specific action specified in the “Task” tab. A processor of client device 52 effects importation of a selected file into a storage device 54 of the document management system according to the file structure tree.

In addition, the apparatus shown in FIG. 5 may be used to render or display document files according to a previously defined, customized file tree. In this case, workstation comprising device 56 and terminal 58 provides a customer or end user with a graphical user interface as shown in FIG. 3. The user interface shows a group of files uniformly arranged and ordered according to the customized file tree, as previously described herein, which may be generated locally and displayed on terminal 58, or produced by the document management system residing on server 52 and memory 54. Any portion of or the entire tree may be displayed for the user's preview and file selection. A scroll bar, not shown, may also be employed to provide convenient perusal of other portions of a large customized file tree. In response to user selection of a file listed in pane 30 (FIG. 3), tags or file identifiers are generated for subsequent use to access files in database 54 having corresponding matching tags or file identifiers that were previously generated and stored with the files during file importation. Once accessed, client device 56 effects automatic retrieval of the document file(s) from storage 54 and/or rendering of that document file(s) on terminal 58. Based on the user's history of access, document files may be cached in a local storage of client device 56 for rapid retrieval and rendering on terminal 58. Once rendered or displayed, the end user may perform a desired action, e.g., analysis, printing, editing, annotating, etc.

In yet another aspect of the invention, there is provided a computer-readable medium, such as a CD-ROM, Internet server, or other conventional memory storage device, that stores program instructions for implementation in a digital data processing system of the aforementioned methods described herein. In particular, the computer-readable medium effects definition/modification of a customized file tree; effects importation by enabling selection of a file and effecting assignment of a position within said file structure tree; effects storage of content in a database according to the file structure tree; or effects uniform display of stored content according to the customized file structure tree. Alternatively, the computer-readable medium may comprise a storage medium of an Internet server and program instructions may be transferred via a network 50, which may be wired or wireless.

Based on the above teachings, variations of the systems or methods described herein may come to those skilled in the art. Thus, the illustrated embodiments do not serve to limit the scope of the invention, which is defined by the appended claims.

1. A computer-implemented method to enable a user to build a customized file tree structure for use in a document management system, said method comprising:
providing a first region of a graphical user interface (scratchpad area) of a computer workstation within which to build (and visualize) the customize file tree structure,
providing a list of available folder types in a second region of said graphical user interface from which to select a folder type,
providing a list of document types in a third region of said graphical user interface from which to select a subclassification of a folder type, and
building the customized file tree structure in said first region by transferring desired folder types from said second region to said first region and further subclassifying said transferred folder types by transferring at least one document type from said third region to said first region for desired ones of said folder types whereby to build said customized file tree structure.

2. The method of claim 1, including storing the customized file tree structure in a document management system for subsequent access and use when importing document files into said system.

3. The method of claim 1, wherein said transferring steps includes dragging and dropping selected folder types and selected document types respectively from said second and third regions to said first region of the graphical user interface.

4. The method of claim 1, further including providing an editing tool to enable a user (classification designer) to create additional folder types or document types in said first, second, or third regions.

5. The method of claim 1, wherein said folder types and document types are designed to characterize insurance underwriting files.

6. A computer-implemented method of enabling a user to construct a customized file tree comprising:
providing the user with an available group of file types, and
enabling the user to construct an ordered, customized file tree by (i) selecting a file type from the available group of file types and placing the selected file type at a desired position in the file tree and (ii) for a file type placed into the file tree.

7. The method of claim 6, further including
providing the user with an available group of document types for said file types, and
selecting at least one document type from the available group of document types and placing said at least one document type at a position in the file tree structure associated with the selected file type.

8. The method of claim 7 further including providing an editing tool to enable the user to define by textually entering into the file tree structure a new folder type and/or an associated new document type.

9. A computer-implemented method of classifying and importing document files into a document management system, said method comprising:
providing a graphical user interface to display a predefined file tree structure in a window thereof,
identifying a first document file to be classified and imported into the document management system,
selecting a location within said predefined file tree structure within which to classify said document file,
importing said first document file into said document management system according to the location identified in the identifying step, and
iteratively repeating said identifying, selecting, and importing steps to classify and import further document files.

10. The method of claim 9, wherein said importing further includes storing said document file in a central file storage system of said document management system.

11. The method of claim 10, further comprising the steps of:
generating a classification identifier tag according to the location identified in said selecting step, and
storing said classification identifier tag along with each said document file when imported into said document management system whereby to enable listing and retrieving said file according to said predefined file tree structure.

12. A computer-implemented method of classifying and importing document files into a document management system comprising displaying a predefined file tree structure in a first region of a graphical user interface, enabling a user (classifier) to identify a document file to be classified according to the predefined file tree structure, selecting a location within the predefined file tree structure displayed in the first region of the graphical user interface, and importing said document file into the document management system according to the selected location of the customized file tree structure.

13. The method of claim 12, wherein the importing step automatically produces a classification tag indicative of a classification assigned to said document file and storing said classification tag along with said document file (or in a separate cross-referenced, linked database records associated with the document file) to enable the document management system to track, maintain, or subsequently retrieve the document file according to the customized file tree structure.

14. The method of claim 13, further comprising storing said classification tag in a linked database associated with said document file.

15. A computer-implemented method of retrieving document files stored in a document management system and classified according to a predefined file tree structure, said method comprising:
obtaining a predefined classification tree structure represented by a group of file identifiers indicative of folder types and document types of said predefined classification tree structure,
accessing document files in a database according to said file identifiers, and
displaying a list of said document files according to said classification tree structure whereby to enable a user to access a desired document file.

16. The method of claim 15, further wherein said displaying step includes displaying said document files in a same ordered arrangement provided by said predefined file tree structure.

17. A method of accessing and retrieving a document file stored in a database of a file management system according to a predefined classification tree structure, said method comprising generating a group of classification identifiers to provide a user with a listing of said document files arranged according to the predefined classification tree structure; choosing a document file from the file listing; retrieving the chosen file from said database; and rendering the chosen document file on an output device.

18. The method of claim 17, wherein said generating step includes searching said database for file identifiers defining the classification of document files according to said predefined classification tree structure, and displaying retrieved files in an ordered arrangement according to said predefined classification tree structure.

19. A document management system to enable a user (classification designer) to build a customized file tree structure, said system comprising a computer workstation including a local processor and display terminal to provide the user with an interactive graphical user interface and a processor to provide a scratchpad area within which to build the customized file tree structure; said workstation further including a first program module to provide a list of available folder types from which to choose and create the customized file tree structure, a second program module to provide a list of available document types from which to further choose and associate with a selected file folder; and a third program module to detect user activity in choosing and building folder types and document types; and a fourth program module to store the customized classification tree structure for subsequent use during file classification or retrieval.

20. The system of claim 19, further including a memory storage device within which to store said customize file tree structure on a central storage device.

21. A document management apparatus to classify document files of a document management system, said apparatus comprising:
a workstation comprising a data processing device and a display terminal including a first program module to provide a classifier with an interactive graphical user interface that displays a predefined classification tree, a second program module to register an identification of a document file made by the classifier, a third program module to register a selection in the predefined classification tree made by the classifier within which to classify the document file, and a fourth program module to effect importation of the document file into a storage of the document management system according to the registered selection within the predefined classification tree.

22. The apparatus of claim 21, further including a fifth program module that generates file identifiers indicative of said predefined classification tree and that stores said file identifiers along with each document file imported into the document management system.

23. A computer-readable medium that stores program instructions for execution by a digital data processor of a document management system to enable a user to build a customized file tree structure, to effect importation of a file into the document management system by enabling selection of a file and effecting assignment of a position within said customized file tree structure; to effect storage of document files in a database according to the file structure tree; and to effect uniform display of document files according to the customized file tree structure.

24. A computer-readable medium that stores program instructions for execution by a digital data processor of a document management system to enable a user to build a customized file tree, said program instructions being effective to provide a first region of a graphical user interface within which to build said customized file tree, to provide a second region of said graphical user interface that provides a list of available file folders within which to classify document files, to provide a third region of said graphical user interface that provides a list of available document types to subclassify selected file folders, and to register actions by the user in building the customize file tree by selecting folder types and document types.

25. The computer-readable medium of claim 24, wherein said program instructions further enable a user to classify and import document files into the document management system by providing a display of the customized file tree and enabling a user to identify a file and a location within the customized file tree to classify and store the document files.
